(19) United States
(12) Patent Application Publication
(10) Pub. No.: US 2004/0175027 A1
(43) Pub. Date: Sep. 9, 2004

(54) Machine vision inspection system and method

(76) Inventors: James Mahon, Dublin (IE); John Wall, Dublin (IE); James Tracey, Dublin (IE); Mark Dullaghan, Trim (IE); Sean Doherty, Dublin (IE)

Correspondence Address: JACOBSON HOLMAN PLLC, 400 SEVENTH STREET N.W., SUITE 600, WASHINGTON, DC, 20004, US

(21) Appl. No.: 10/792,763

(22) Filed: Mar. 5, 2004

(30) Foreign Application Priority Data
Mar. 7, 2003 (EP) EP03394024.8

(51) Int. Cl. G06K 9/00

(52) U.S. Cl. 382/141

(57) ABSTRACT

A machine vision system has an illumination head (1) with seven rings of LEDs 2-8, each having a different elevational angle. Each ring is configured with a particular current level, thereby setting its intensity. Rings 3 and 4 are green and blue, the other rings being red. A controller controls illumination by varying one or a combination of elevation, azimuth quadrant (or 45° octant), intensity, and colour. For example an image may be captured with fully surrounding, North quadrant, South quadrant, East quadrant, and West quadrant illuminations. Alternatively, there may be both North-South illumination for one image and East-West for another.

### FIELD OF THE INVENTION

The invention relates to machine vision inspection.

### PRIOR ART DISCUSSION

In recent years the demands on machine vision inspection machines have increased because of ever-increasing circuit component density, miniaturisation, and production line throughput rates. It has become particularly difficult to consistently inspect solder joints with the desired accuracy because of the ever-decreasing size of the solder deposits (pre and post reflow) and the fact that the field of view is often partially blocked by neighbouring components.

Also, in many instances the profile or contour (shape) of a solder joint or other deposit is very important for operation of the circuit in the field. Existing machine vision systems and methods fail to provide adequate information concerning the profiles.

WO99/22224 (Vista) describes an illumination system with a domed head having rings of LEDs. Light from all of the LEDs illuminates a central inspection point, and there is intensity control of the LEDs. DE4123916 (Malz) describes a system for inspecting ceramics. A light array on one side of an object directs light which is reflected from the scene and captured at the opposing side. An intense source of illumination is movably mounted behind a dome array, and the dome array provides background illumination. WO0169214 (Optomachines) describes an arrangement in which a number of light sources are arranged to provide illumination which is reflected from a diffuser dome onto the scene. EP0443289 describes an arrangement in which four cameras acquire multiple images of a scene from different angles.

### SUMMARY OF THE INVENTION

According to the invention, there is provided a machine vision inspection system comprising:

a camera mounted with its axis normal to a scene to be inspected;

an illuminator;

an image processor connected to the camera; and

a controller for directing acquisition of a plurality of images of a single scene by the camera and the image processor, in which the controller directs a different illumination for each image.

Having multiple images of the same scene, captured with different illuminations provides comprehensive data in a simple manner.

In one embodiment, the controller controls azimuth angle of illumination.

In another embodiment, the illuminator comprises light sources mounted around the normal axis and a driver for illuminating light sources for only a particular range of azimuth angles for an image.

In a further embodiment, the controller directs illumination by light sources in one or more azimuth sectors.

In one embodiment, the controller directs simultaneous activation of light sources of diagonally opposed azimuth sectors for acquisition of an image.

In another embodiment, the controller controls elevational angle of illumination.

In a further embodiment, there are a plurality of rings of light sources, each illuminating at a different elevation.

In one embodiment, the controller directs activation of only a subset of light sources in an azimuth sector for an image.

In another embodiment, at least one ring has LEDs of a different colour, and the controller controls illumination at least partly on the basis of colour.

In a further embodiment, the controller activates light sources of different colours simultaneously for diffuse illumination.

In one embodiment, the controller drives some light sources with a different intensity from other light sources.

In another embodiment, the controller drives different light source rings with different intensities.

In a further embodiment, the controller controls illumination on the basis of one or a combination of light source elevation, azimuth, intensity, and colour for each of a plurality of images of a scene.

In one embodiment, the image processor generates a display in which data from an image is distinguished visually for an operator on the basis of colour.

In another embodiment, the image processor generates a set of displays of images simultaneously on a screen.

In a further embodiment, at least one of the displays is of a combination of a plurality of images corresponding to different illuminations.

In one embodiment, the controller directs capture of an image for which the scene is illuminated from all sides.

In another embodiment, the scene is illuminated by a ring of light sources having a diameter greater than a width dimension of the scene.

In a further embodiment, the controller directs capture of:

(a) a first image with illumination from a large range of azimuth angles;

(b) a second image with illumination from a smaller range of azimuth angles, said range including some of the range for the first image; and

(c) subtracting the second image from the first image to derive a third image.

In one embodiment, said first image is captured with fully surrounding illumination.

In another embodiment, the second image has illumination from a pair of opposed azimuth sectors, and the derived image simulates an image captured with illumination from orthogonally opposed sectors.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a cross-sectional elevational view of an illumination head of a machine vision system of the invention, and

FIG. 2 is a perspective view;

FIGS. 3 and 4 are plan and perspective views of a lower part of the head;

FIGS. 5(a) to 5(f) are diagrammatic representations of six possible illumination scenarios;

FIG. 6 is a diagram showing derivation of East-West illumination;

FIGS. 7(a), 7(b), and 7(c) are sample system output images; and

FIG. 8 is a perspective and underneath plan view of an alternative head of the invention.

### DESCRIPTION OF THE EMBODIMENTS

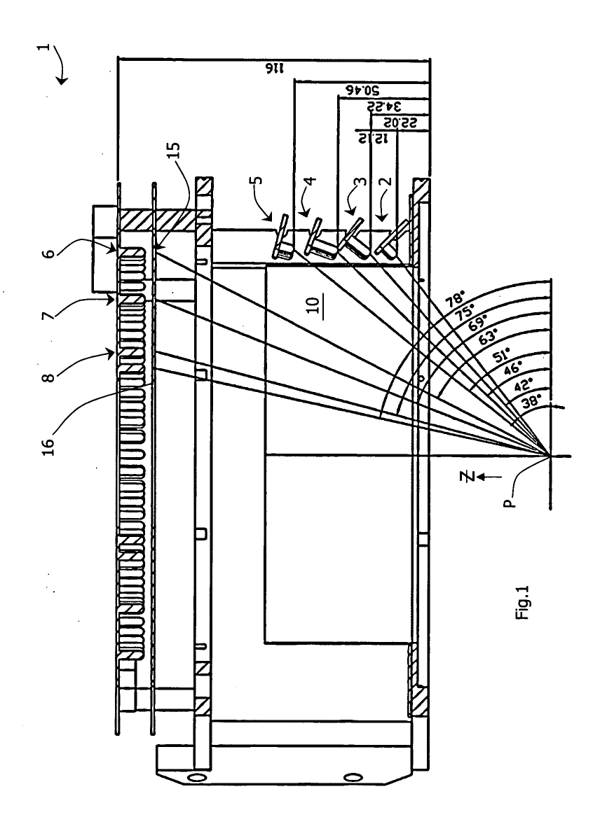

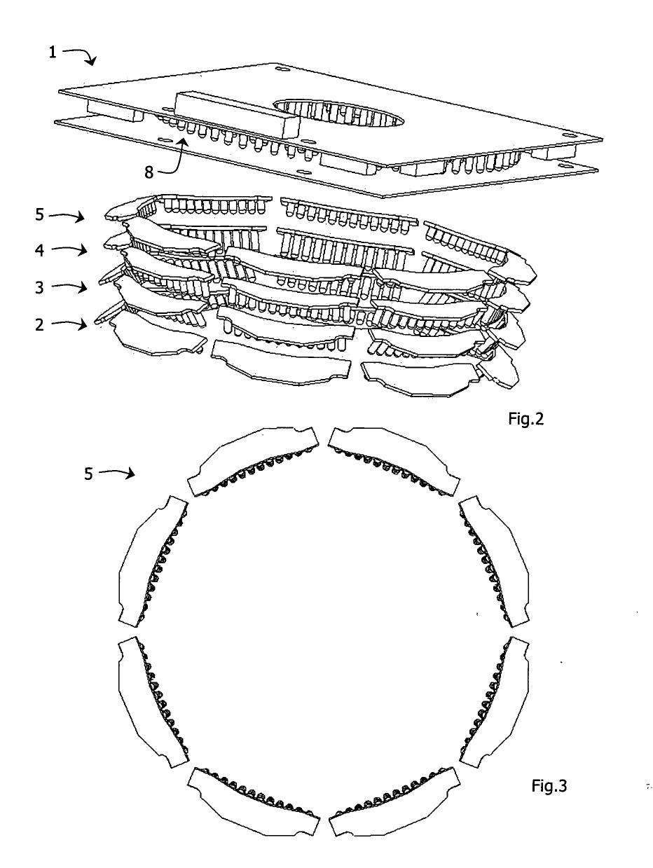

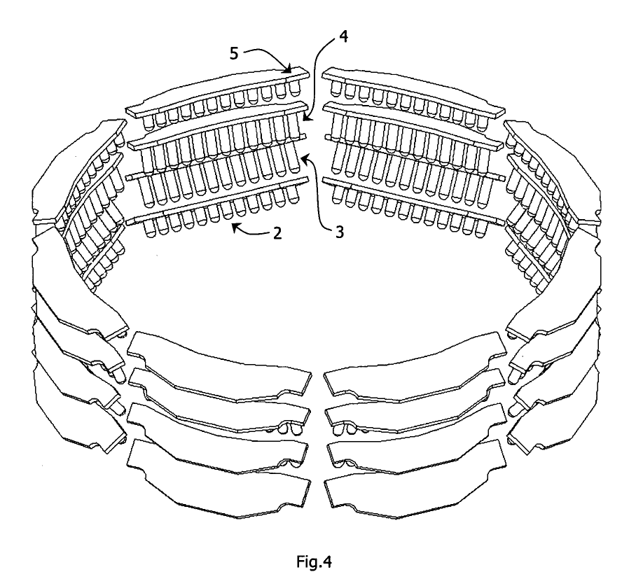

A machine vision system of the invention comprises a CCD camera mounted on-axis (normal to the scene, denoted “Z”) and an illumination head 1 shown in FIGS. 1 to 4.

The head 1 comprises, in succession vertically,

a 38° ring of LEDs 2 of colour red,

a 42° ring of LEDs 3 of colour green,

a 46° ring of LEDs 4 of colour blue, and

a 51° ring of LEDs 5 of colour red.

The rings of LEDs 2-5 are arranged one above the other in the Z direction with spacings as indicated in mm and with the same diameter. A diffuser 10 is provided to achieve a flat field illumination of an area of the scene which is larger than the camera field of view.

The head 1 also comprises three rings of LEDs 6, 7, and 8 at the same Z level and cocentric. The details are:

ring 6 is 63° and has colour red,

ring 7 is 75° and has colour red, and

ring 8 is 78° and has colour red.

Light from the LEDs 6, 7, and 8 is directed by a Fresnel lens 15 having a central aperture 16 to provide a camera field of view of the scene under inspection. The Fresnel lens 15 allows the LEDs 6, 7, and 8 to illuminate uniformly across the illuminated area of the scene.

In the diagrams each ring 2-8 is only one LED wide, however, they may be two or more wide depending on the application. Where there are multiple rows in each ring, the LEDs are preferably offset with respect to the LEDs of the next row.

The drive circuits for the LEDs are arranged so that they can individually illuminate one or more 45° sectors (octants) as viewed in underneath plan. Additionally, the LEDs can be driven in individual subsets of sectors, each subset having some or all LEDs from one, two, three, or four of the rings 2-8. Adjoining octants may be simultaneously activated to provide quadrant lighting. In this specification the term “range of azimuth angles” means a range of angles as viewed in plan around an axis normal to the scene. For example one range of azimuth angles is a 45° “North” quadrant.

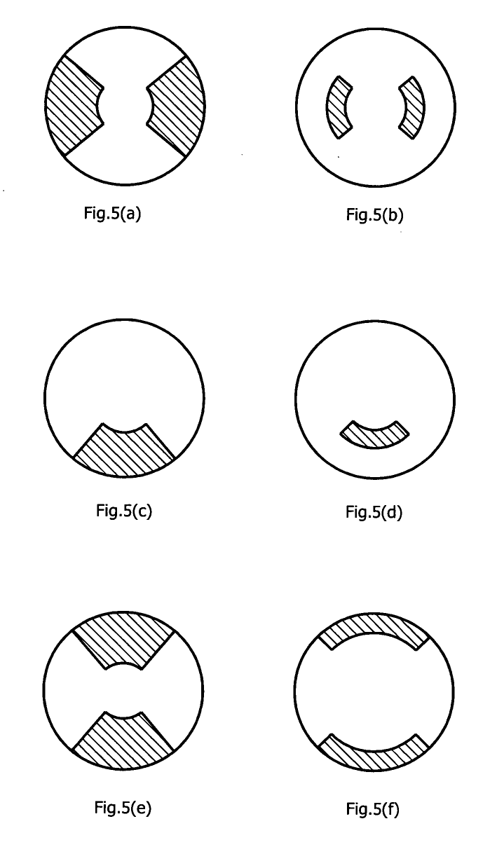

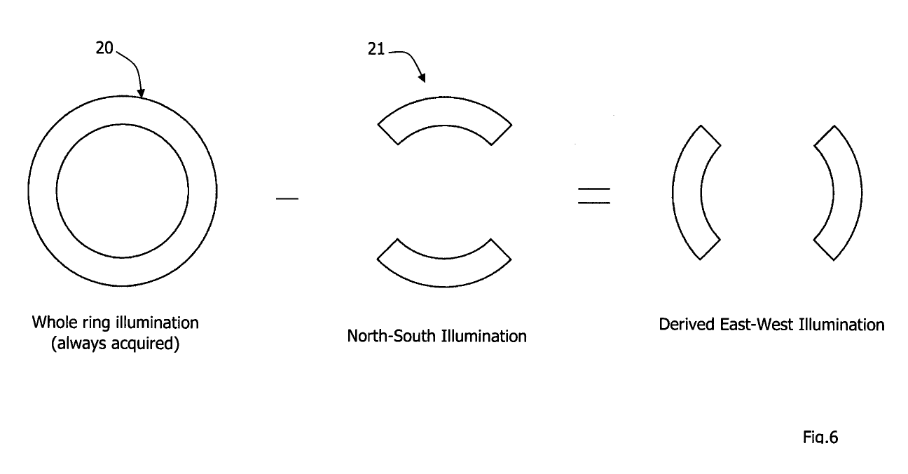

Referring to FIGS. 5(a) to 5(f) some example illumination scenarios are shown diagrammatically in underneath plan view:

FIG. 5(a): two adjoining 45° sectors on each of “East” and “West” sides, forming full “East” and “West” quadrants;

FIG. 5(b): in each of the “East” and “West” quadrants only two adjacent rings being activated;

FIG. 5(c): a full “South” quadrant activated;

FIG. 5(d): only part of the “South” quadrant activated;

FIG. 5(e): both “North” and “South” quadrants activated;

FIG. 5(f): only smaller-angle rings of the “North” and “South” quadrants activated.

While the circuits are arranged for illumination in 45° sectors, the basic unit is a 90° “North”, “South”, “East”, or “West” quadrant. However, the benefit of having a 45° sub-divisions is that the North-South axis can be “rotated” by 45° if the scene so requires. Also, this allows rotated components to be imaged correctly.

In one mode the LEDs are driven to capture three images of a scene:

whole scene illumination,

“North”-“South” illumination,

“East”-“West” illumination.

In a variation of this mode one of these images can be derived, thus saving one acquisition per cycle. As shown in FIG. 6 a whole scene LED configuration 20 is activated, followed by a “North”-“South” activation. The “East”-“West” activation is then derived by subtracting the image for the illumination 21 from that for the illumination 20. This arrangement considerably reduces cycle time. Image derivation can be performed for many illumination schemes. Indeed, where there are cycles involving both N-S and E-W images it can be used to derive two images, thus saving two acquisitions.

Each LED ring 2-8 has a configurable current value, setting the intensity. Thus, for any inspection or batch of inspections the controller can set a desired intensity level for each ring. Thus, the head 1 allows illumination control on the basis of varying one or a combination of:

(a) Elevation, by choosing a ring or rings 2-8 having the desired elevational angle (38°, 42°, 46°, 51°, 63°, 75°, and 78°).

(b) Azimuth, by choosing which octant(s) or quadrant(s) to activate.

(c) Intensity, by setting a current value on the lighting controller.

(d) Colour by choosing red (LEDs 2, 5, 6, 7, and/or 8), green (LEDs 3), and/or blue (LEDs 4).

Therefore, there is excellent versatility in the illumination arrangement for optimum image acquisition in any particular situation. The head is particularly suitable for post-reflow solder joint inspection. The richness of the data which can be extracted from the scene allows accurate object (e.g. solder or component) shape to be reconstructed.

### EXAMPLE 1

The camera captures six images of a particular group of solder joints as follows.

Image 1: “Top” illumination from the red LEDs 6 and 7 (full rings).

Image 2: “North” quadrant illumination using some LEDs from each ring 2-8 (combination of red, green, and blue or just a single colour).

Image 3: “South” quadrant illumination using some LEDs from each ring 2-8 (combination of red, green, and blue or just a single colour).

Image 4: “East” quadrant illumination using some LEDs from each ring 2-8 (combination of red, green, and blue or just a single colour).

Image 5: “West” quadrant illumination using some LEDs from each ring 2-8 (combination of red, green, and blue or just a single colour).

Image 6: “High” illumination from the red LEDs 8 only.

The image processor uses the six images to reconstruct the shape of the scene. The sum of the information from all six images is greater than that of only one image captured with illumination from all sides. Illumination from only one side across a range of angles in a Z plane provides information on the contour. For example, it indicates if a solder joint is concave or convex on one side.

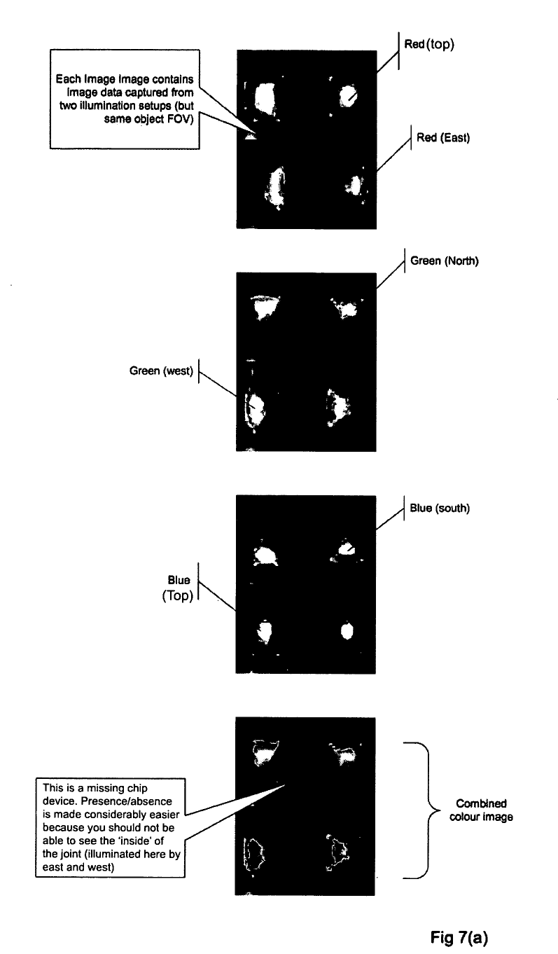

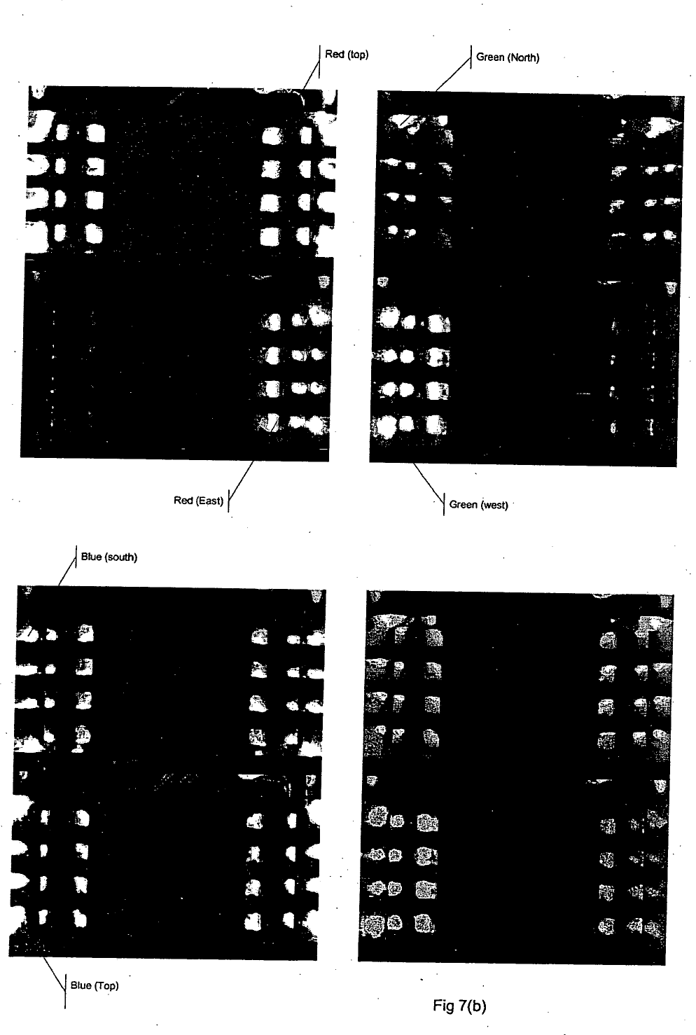

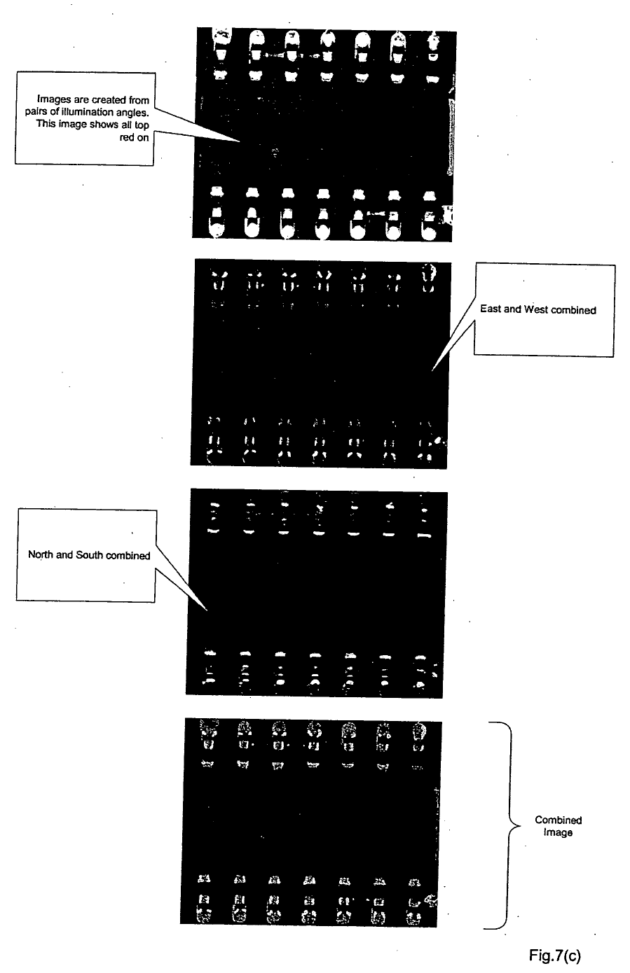

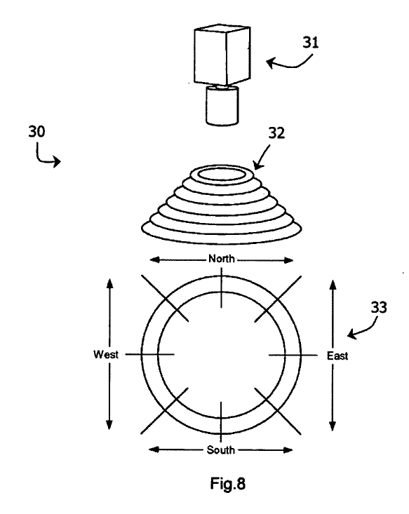

Referring to FIG. 7(a) a solder joint is inspected by capturing six images: display colour red from top (63°, LEDs 6), display colour red East (38°, LEDs 2), display colour green north (38°, LEDs 2), display colour green West (38°, LEDs 2), display colour blue south (38°, LEDs 2), and display colour blue (top, 78°, LEDs 8). The lower image of FIG. 7(a) is a combined colour image captured with all LEDs activated. The images have six planes and it is difficult to display such images.

However, it is simple to display three plane images as “colour” images. To display six planes, the system displays two colour images (one above the other).

It should be noted that these colours are display colours, not related to the LED colours. The different display colours allow users to easily differentiate illumination scenarios.

FIG. 7(b) shows sample images of another scene with a similar illumination sequence as for FIG. 7(a).

FIG. 7(c) shows four images: illumination from top with all LEDs 6, 7, and 8; illumination from east and west with LEDs 2; illumination from north and south with LEDs 2; and a combined image.

The system generates displays for the process engineer in which a different display colour is used for each image. The display colours are not linked with the illumination colours. They are only used to visually distinguish for the process engineer one image from another. Thus a “North” facing joint shoulder will be displayed primarily with the colour associated with Image 1. However another colour for part of this shoulder tells the trained engineer much about its profile.

The inspection method may be used to selectively carry out further inspection of failed joints. Such inspection may be carried out at a repair station, giving a comprehensive “reconstruction” view of a failed joint before repair. The repair station may have a stereo viewing headset or lenticular display giving a 3D view of the joints. The user could “rotate” the solder joint in three dimensions for easier viewing of the solvent features. Rotation is effected by successively driving each sector in turn.

It will be appreciated that the invention allows a comprehensive assessment of joint quality to be made, with more accurate classification of errors.

The invention is not limited to the embodiments described but may be varied in construction and detail. For example, the angles of the LED rings may be different from those described. Indeed, the LEDs may be arranged in an array, possibly domed, inserted of in rings. Also, the LED arrangement may be different. An alternative example is shown in FIG. 8, in which a camera 31 captures images with illumination from one or more concentric rings 32 with an overall conical configuration with gradually increasing diameter downwards. It is also envisaged that the colour and intensity control may be on a basis other than rings, such as vertical plane rows spanning multiple elevations.

1. A machine vision inspection system comprising:
a camera mounted with its axis normal to a scene to be inspected;
an illuminator;
an image processor connected to the camera; and
a controller for directing acquisition of a plurality of images of a single scene by the camera and the image processor, in which the controller directs a different illumination for each image.

2. A system as claimed in claim 1, wherein the controller controls azimuth angle of illumination.

3. A system as claimed in claim 2, wherein the illuminator comprises light sources mounted around the normal axis and a driver for illuminating light sources for only a particular range of azimuth angles for an image.

4. A system as claimed in claim 2, wherein the controller directs illumination by light sources in one or more azimuth sectors.

5. A system as claimed in claim 4, wherein the controller directs simultaneous activation of light sources of diagonally opposed azimuth sectors for acquisition of an image.

6. A system as claimed in claim 1, wherein the controller controls elevational angle of illumination.

7. A system as claimed in claim 6, wherein there are a plurality of rings of light sources, each illuminating at a different elevation.

8. A system as claimed in claim 7, wherein the controller directs activation of only a subset of light sources in an azimuth sector for an image.

9. A system as claimed in claim 7, wherein at least one ring has LEDs of a different colour, and the controller controls illumination at least partly on the basis of colour.

10. A system as claimed in claim 9, wherein the controller activates light sources of different colours simultaneously for diffuse illumination.

11. A system as claimed in claim 7, wherein the controller drives some light sources with a different intensity from other light sources.

12. A system as claimed in claim 11, wherein the controller drives different light source rings with different intensities.

13. A system as claimed in claim 1, wherein the controller controls illumination on the basis of one or a combination of light source elevation, azimuth, intensity, and colour for each of a plurality of images of a scene.

14. A system as claimed in claim 1, wherein the image processor generates a display in which data from an image is distinguished visually for an operator on the basis of colour.

15. A system as claimed in claim 14, wherein the image processor generates a set of displays of images simultaneously on a screen.

16. A system as claimed in claim 15, wherein at least one of the displays is of a combination of a plurality of images corresponding to different illuminations.

17. A system as claimed in claim 1, wherein the controller directs capture of an image for which the scene is illuminated from all sides.

18. A system as claimed in claim 17, wherein the scene is illuminated by a ring of light sources having a diameter greater than a width dimension of the scene.

19. A system as claimed in claim 1, wherein the controller directs capture of:
(a) a first image with illumination from a large range of azimuth angles;
(b) a second image with illumination from a smaller range of azimuth angles, said range including some to the range for the first image; and
(c) subtracting the second image from the first image to derive a third image.

20. A system as claimed in claim 19, wherein said first image is captured with fully surrounding illumination.

21. A system as claimed in claim 20, wherein the second image has illumination from a pair of opposed azimuth sectors, and the derived image simulates an image captured with illumination from orthogonally opposed sectors.
